(19) United States
(12) Patent Application Publication
(10) Pub. No.: US 2025/0050443 A1
(43) Pub. Date: Feb. 13, 2025

(54) DYNAMIC CONNECTORS FOR WELDING CABLES AND WELDING TORCHES

(71) Applicant: ILLINOIS TOOL WORKS INC., Glenview, IL (US)

(72) Inventor: Ryan Lizotte, Ontario (CA)

(21) Appl. No.: 18/779,678

(22) Filed: Jul. 22, 2024

Related U.S. Application Data
(60) Provisional application No. 63/531,852, filed on Aug. 10, 2023.

(51) Int. Cl. B23K 9/28

(52) U.S. Cl. CPC B23K 9/28

(57) ABSTRACT

An example dynamic connector for a welding torch is provided. An example dynamic connector for a welding torch includes a conductive adapter configured to connect to a wire feeder on a first end and comprising a bore on a second end, a pin positioned within the bore and configured to couple the conductive adapter to a welding cable, wherein the pin is configured to travel with respect to the bore in response to force on the welding cable, one or more electrical contact rings configured to maintain an electrical connection between the conductive adapter and the pin while the pin is within the bore, and one or more bearings configured to support the pin while the pin is within the bore.

### CROSS REFERENCE TO RELATED APPLICATIONS

This application claims priority from and the benefit of U.S. Provisional Application Ser. No. 63/531,852, entitled “DYNAMIC CONNECTORS FOR WELDING CABLES AND WELDING TORCHES,” filed Aug. 10, 2023, the entirety of which is hereby incorporated by reference.

### FIELD OF THE DISCLOSURE

This disclosure relates generally to robotic welding and more particularly, to dynamic connectors for welding cables and welding torches.

### BACKGROUND

A welding torch and welding cable are typically used to perform arc welding. Typically, the power cable provides current, shielding gas, and electrode wire to the welding torch and includes two fixed connections: one end of the power cable is fastened to a wire feeder by way of a mating pin (or power pin), and the other end is fastened to a torch body with a gooseneck or conductor tube of the welding torch.

### SUMMARY

These and other features and advantages of the disclosure will be more fully understood from the following detailed description of the disclosure taken together with the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example robotic welding system, including a robot having a welding torch and a welding cable that travels through an interior of the robotic welding system, in accordance with aspects of this disclosure

FIG. 2 illustrates a block diagram of an example dynamic connector that may be used to implement the robotic welding system of FIG. 1.

FIG. 3 illustrates a schematic diagram of the example dynamic connector of FIG. 2, in accordance with aspects of this disclosure.

FIG. 4 illustrates a sectional view of an example implementation of the dynamic connector of FIG. 2.

FIG. 5 is a sectional view of another example dynamic connector 500 that may be used to implement the dynamic connector 200 of FIG. 2.

FIG. 6 is a flowchart illustrating an example method of removing and replacing the dynamic connector of FIG. 2.

The figures are not necessarily to scale. Where appropriate, similar or identical reference numbers are used to refer to similar or identical components.

### DETAILED DESCRIPTION

This disclosure relates to welding generally, and more particularly to dynamic connectors for connecting a welding cable to a wire feeder. In particular, example dynamic connectors are disclosed that may be affixed to a wire feeder. Disclosed example dynamic connectors reduce strain or stress on cabling by providing a connection between the welding cable and the wire feeder that allows for sliding and rotation of a power pin relative to the wire feeder, while also providing continual electrical connection at high current levels employed in welding applications.

During manipulation of the welding torch by a user or a robot, conventional welding cables are subject to twisting and other stresses as the welding torch is moved and rotated. Twisting and stress can be problematic as the welding cable is subjected to stress and strain, and can cause failure of the welding cable. Conventional welding cables are fixed at both ends (front and rear) with some slack left between the fixed points. Some systems employ a rotating element at the front end to allow for rotation about the cables' axis and at one of the robot joints.

Since conventional welding cables are fixed at the front connector and the power pin is fixed into the feeder at the back, the welding cable builds up stress/strain as the robot moves. Buildup of stress/strain can lead to the breakdown of copper strands within the cable bundle as the copper strands are forced between being in tension and compression states. Additionally, the rotation about the cables' axis and at the robot joints, as well as improper cable lengths near the wire feeder, can cause conventional welding cables to fail prematurely.

Replacing failed welding cables requires unplanned downtime and removing various connectors in order access the welding cable. Additionally, power pins of conventional welding cables must be removed from the wire feeder, connected to the new welding cable, re-threaded with welding wire, and then re-tightened into the wire feeder. Often, the pin is not properly tightened to the cable and/or the wire feeder, which leads to increased resistance, heat, and premature failure of the welding cable liner, welding cable, and consumables, etc. In some instances, a loose pin may even lead to robot/wire feeder damage, which in turn causes more unplanned downtime.

The present disclosure provides a dynamic connection that may be secured directly to a wire feeder. The present disclosure advantageously allows for sliding and rotation of the welding cable relative to the wire feeder without breaking electrical contact or putting unnecessary strain on the welding cable. The dynamic connector allows axial movement of the welding cable during movement of the welding torch, which in turn allows the welding cables' stress and/or strain to be released in real-time. By utilizing a dynamic connector at the wire feeder end of the welding cable, the effective length of the welding system can adjust to ensure the cable remains in a neutral position, thereby prolonging cable life.

By utilizing a dynamic connector that includes a sliding mechanism, the number of parts needed at the wire feeder can be reduced, thereby reducing the number of connections between the welding torch neck and the wire feeder. Additionally, the dynamic connector may be sized based on different robot makes and/or models, thereby allowing the consolidation of cable lengths and dynamic connectors, leading to efficiencies in manufacturing, as well as in welding-type processes and applications.

The present disclosure also advantageously allows a simpler replacement of the welding cable by allowing a portion of the dynamic connector to remain connected to the wire feeder while the welding cable and/or the welding cable liner are replaced.

Disclosed example dynamic welding connectors include a welding system including a conductive adapter configured to connect to a wire feeder on a first end and including a bore on a second end, a pin positioned within the bore and configured to couple the conductive adapter to a welding cable, wherein the pin is configured to travel with respect to the bore in response to force on the welding cable, one or more electrical contact rings configured to maintain an electrical connection between the conductive adapter and the pin while the pin is within the bore, and one or more bearings configured to support the pin while the pin is within the bore.

In some example dynamic connectors, the one or more electrical contact rings include a socket with spring-loaded contacts biased toward a longitudinal axis of the socket. In some example dynamic connectors, the pin is removable from the socket. Some example dynamic connectors are configured to rotate along an axis of the pin.

Some example dynamic connectors comprise a retention fastener that is configured to limit travel of the pin. In some example dynamic connectors, the pin is configured to slide toward and away from the wire feeder. In some example dynamic connectors, the dynamic connector further comprises a spring configured to bias the welding cable away from the wire feeder. In some example dynamic connectors, the spring encircles a pair of telescoping tubes.

Some example dynamic connectors include a seal configured to reduce leakage of gas. Some example dynamic connectors include a liner retainer configured to remain within the dynamic connector. Some example dynamic connectors include a gas port configured to receive gas and provide the gas to the sliding connector.

Some example welding systems include a robotic arm, a welding cable, a wire feeder, a welding torch attached to the robotic arm, and a dynamic connector. In some example welding systems, the dynamic connector includes a conductive adapter configured to connect to the wire feeder on a first end and including a bore on a second end, a pin positioned within the bore and configured to couple the conductive adapter to the welding cable, wherein the pin is configured to travel within the bore in response to force on the welding cable, one or more electrical contact rings configured to maintain an electrical connection between the conductive adapter and the pin while the pin is within the bore, and one or more bearings configured to support the pin while the pin is within the bore.

As used herein, the terms “first” and “second” may be used to enumerate different components or elements of the same type, and do not necessarily imply any particular order.

As used herein, the words “exemplary” and “example” mean “serving as an example, instance, or illustration.” The examples described herein are not limiting, but rather are exemplary only. It should be understood that the described examples are not necessarily to be construed as preferred or advantageous over other examples. Moreover, the terms “examples of the invention,” “examples,” or “invention” do not require that all examples of the invention include the discussed feature, advantage, or mode of operation.

The term “welding-type system,” as used herein, includes any device capable of supplying power suitable for welding, plasma cutting, induction heating, Carbon Arc Cutting-Air (e.g., CAC-A), and/or hot wire welding/preheating (including laser welding and laser cladding), including inverters, converters, choppers, resonant power supplies, quasi-resonant power supplies, etc., as well as control circuitry and other ancillary circuitry associated therewith.

As used herein, the term “welding-type power” refers to power suitable for welding, plasma cutting, induction heating, CAC-A and/or hot wire welding/preheating (including laser welding and laser cladding). As used herein, the term “welding-type power supply” and/or “power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, the term “torch,” “welding torch,” “welding tool” or “welding-type tool” refers to a device configured to be manipulated to perform a welding-related task, and can include a hand-held welding torch, robotic welding torch, gun, gouging tool, cutting tool, or other device used to create the welding arc.

As used herein, the term “welding mode,” “welding process,” “welding-type process” or “welding operation” refers to the type of process or output used, such as current-controlled (CC), voltage-controlled (CV), pulsed, gas metal arc welding (GMAW), flux-cored arc welding (FCAW), gas tungsten arc welding (GTAW, e.g., TIG), shielded metal arc welding (SMAW), spray, short circuit, CAC-A, gouging process, cutting process, and/or any other type of welding process.

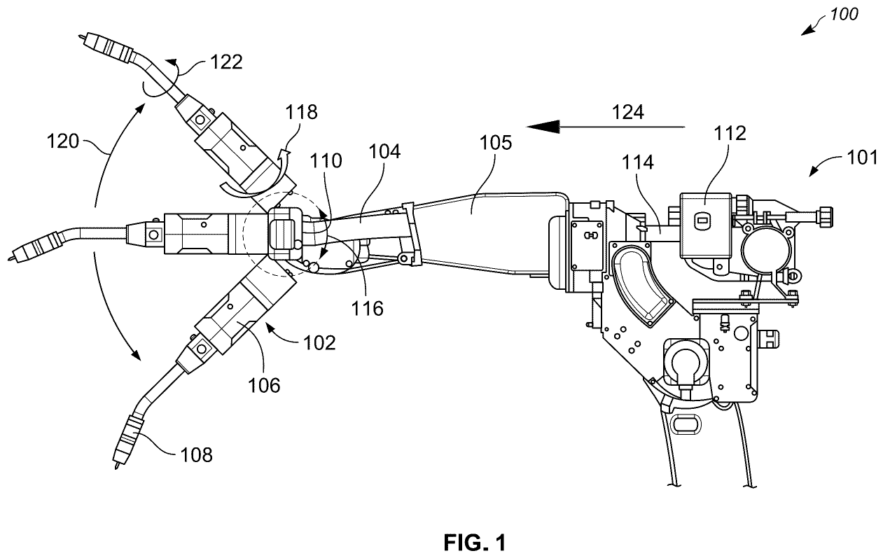

FIG. 1 illustrates an example robotic welding system 100. The robotic welding system 100 includes a through-arm robot 101 having a welding torch 102 and a welding cable 104 that travels through an interior of a robot arm 105 of the robot 101.

The torch 102 includes a torch body 106 and front components 108. The example robot 101 manipulates the front components 108 via the torch body 106 to position the torch 102 for welding operations. FIG. 1 illustrates the example torch 102 in multiple positions resulting from manipulation by the robot 101.

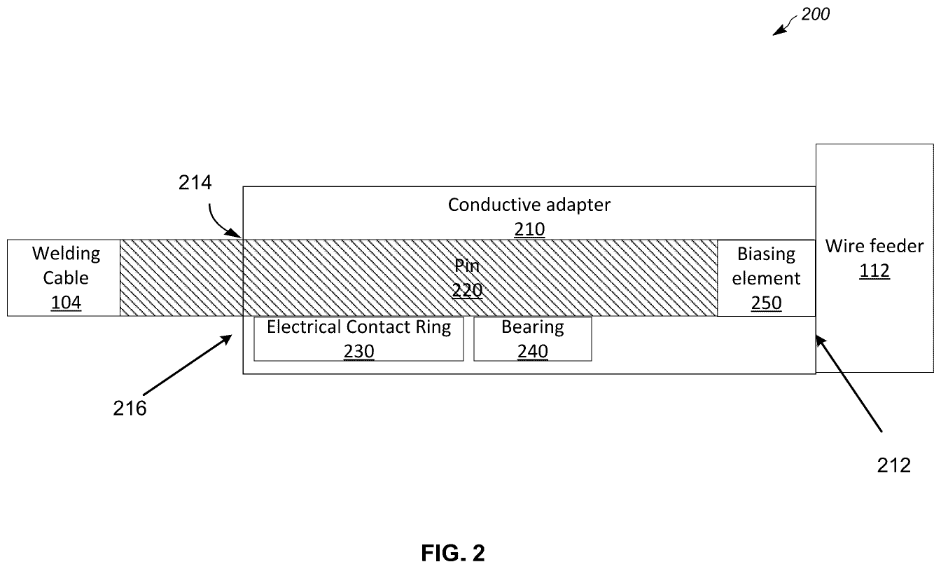

The welding cable 104 is connected to the torch body 106 at a first end 110, and is connected to a wire feeder 112 through a dynamic connector 114, which is described in further detail in FIG. 2 below. The welding cable 104 delivers wire electrode, welding power, and/or welding gas to the torch 102.

The robot 101 may manipulate the torch 102 in multiple degrees of freedom. Two particular movements by the robot 101 affect the contour (e.g., stress and/or strain) of the welding cable 104. A joint 5 (J5) 116 that applies bending 120 to the torch 102, and a joint 6 (J6) 118 applies twist to the torch 102. An example bending limit 120 for the J5 joint 116 is +/−140 degrees. An example twist limit 122 for the J6 joint 118 is +/−360 degrees. Movements of other joints in the robot 101 change the absolute position of the torch 102 but do not change the contour of the welding cable 104. For example, as the J5 joint 116 bends, the welding cable 104 may be pulled by a force similar to 124 and the welding cable 104 length may grow and shrink approximately 0.5″. As the J6 joint 118 twists, the welding cable 104 may twist. The dynamic connector 114 at provides additional rotation at a location between the wire feeder 112 and the welding cable 104, thereby providing additional rotation to the welding cable 104.

FIG. 2 illustrates a block diagram of an example dynamic connector 200 that may be used to implement the robotic welding system of FIG. 1. In some examples, the dynamic connector includes a conductive adapter 210, a pin 220, one or more electrical contact rings 230, and one or more bearings 240. The conductive adapter 210 may also include a biasing element 250 such as a spring, which encircles one or more telescoping tubes (not shown). The biasing element 250 serves to bias the pin 220 and the welding cable 104 away from the wire feeder 112 and towards the welding torch. The conductive adapter 210 and the pin 220 are constructed of a conductive material such as copper and/or brass.

The conductive adapter 210 connects to a wire feeder (e.g., the wire feeder 112 of FIG. 1) at a first end 212 and includes a bore 214 or opening at a second end 216. The conductive adapter 210 includes a pin 220 positioned within the bore 214 and configured to couple the conductive adapter 210 to a welding cable 104. The pin 220 slides within the bore 214 in response to a force on the welding cable 104, which may be a result of, for example, movement of the welding torch 102 as described above with regards to FIG. 1. The pin 220 slides toward and away from the wire feeder 112 along a longitudinal axis of the pin 220. In some examples, the pin 220 is removable from the bore 214 and the pin 220 is configured to rotate and/or slide along an axis of the pin 220.

In alternative examples, the conductive adapter 210 connects to the welding cable 104 and the pin 220 connects to the wire feeder. The conductive adapter 210 slides toward and away from the wire feeder 112 and is connected to the welding cable via one or more fasteners, such as a threaded interface, locking screws, set screws, or a crimp connector as a list of non-limiting examples. The pin 220 is directly connected to the wire feeder 112.

In some examples, the one or more electrical contact rings 230 are configured to maintain an electrical connection between the conductive adapter 210 and the pin 220. In some examples, the one or more bearings 240 are configured to support the pin 220, and/or to reduce translational and/or rotational friction. The one or more electrical contact rings 230 comprise a socket with spring-loaded contacts which are biased toward a longitudinal axis of the socket. While the pin 220 is within the electrical contact rings 230, the spring-loaded contacts maintain electrical contact with the pin 220 as the pin rotates and slides within the bore 214. The electrical contact rings are distributed around the bore 214 in the socket, while gas and other fluids flow through a center of the pin 220. In some examples, the electrical contact rings 230 are PowerBud® connectors.

In some examples, the dynamic connector 200 is compatible with multiple different types of wire feeders (e.g., different makes and/or models), such as by being configured to be coupled to standard types of wire feeder connectors. In some other examples, the dynamic connector 200 is replaceable with other versions to match a particular type, make, and/or model of dynamic connector 200 to a particular type, make, and/or model of wire feeder.

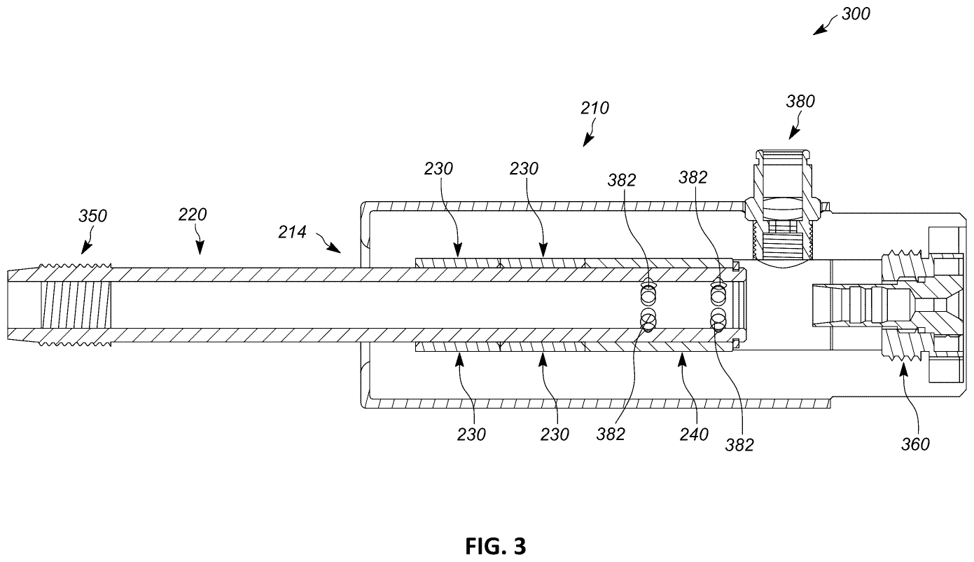

FIG. 3 illustrates a schematic diagram 300 of the example dynamic connector 200 described with respect to FIG. 2. As described above with reference to FIG. 2, the dynamic connector 200 includes a conductive adapter 210, a pin 220, one or more electrical contact rings 230, and one or more bearings 240.

The conductive adapter 210 connects to a wire feeder such as the wire feeder 112 of FIG. 1 at a first end 212 and includes a bore 214 at a second end 216. The conductive adapter 210 comprise one or more structural components. The conductive adapter 210 includes a pin 220 positioned within the bore 214 and configured to couple the conductive adapter 210 to a welding cable at the second end near the bore 214. In some examples, the pin 220 slides within the bore 214 in response to a force on the welding cable 104, which may be a result of for example, movement of the welding torch and/or the welding cable. In some examples, the pin 220 is able to rotate and/or slide along a longitudinal axis of the pin 200 toward and away from a wire feeder.

In the disclosed example of FIG. 3, the pin 220 is configured to slide in and out of the bore 214 including the electrical contact rings 230, and forms an electrical connection with the electrical contact rings 230. The electrical contact rings 230 may be spring-loaded contacts which are biased toward a longitudinal axis of the pin. In some examples, the spring-loaded contacts are separated by gaps.

In some examples, the pin 220 is connected at 350 to the welding cable via one or more fasteners, such as a threaded interface, locking screws, set screws, or a crimp connector as a list of non-limiting examples. A crimp connector may be any type of coupler that provides a radial force to secure the wire feeder to the dynamic connector (e.g., a crimped-style fitting, a compression fitting, a threaded compression fitting, etc.). The crimp connector may be secured to the pin via a connection, such as a thread and set screw connection, but may also include a press-fit, knurled press-fit, snap-fit, screws, bolts, adhesive, a weld, braze, or other type of fastener. Additionally or alternatively, the conductors of the welding cable may be ultrasonically welded, or otherwise bonded, to the connector. Conductive wires (e.g., copper wires) of the welding cable may be crimped to form a solid electric connection between the welding cable and the crimp connector.

In some examples, the conductive adapter 210 is connected to the wire feeder via a direct connection, such as a fastener (e.g., as a thread and set screw connection, screws, bolts, adhesive, a weld, braze, or other type of fastener that secures the conductive adapter 210 to the wire feeder.

In the example of FIG. 3, a cable liner retainer 360 is inserted into the conductive adapter 210 and may remain in the conductive adapter 210, even during a welding cable replacement. The conductive adapter 210 may also include one or more seals 370 between the pin 220 and the conductive adapter 210, to reduce leakage of shielding gas provided through a gas port 380 and ensure the gas travels through gas openings 382 and into the pin 220. For example, the conductive adapter 210 may include or more washers, O-rings, or similar seals, arranged at the end of the conductive adapter 210 from which the pin 220 extends, or the conductive adapter 210 may include a sealing foam or other similar agent within the conductive adapter 210.

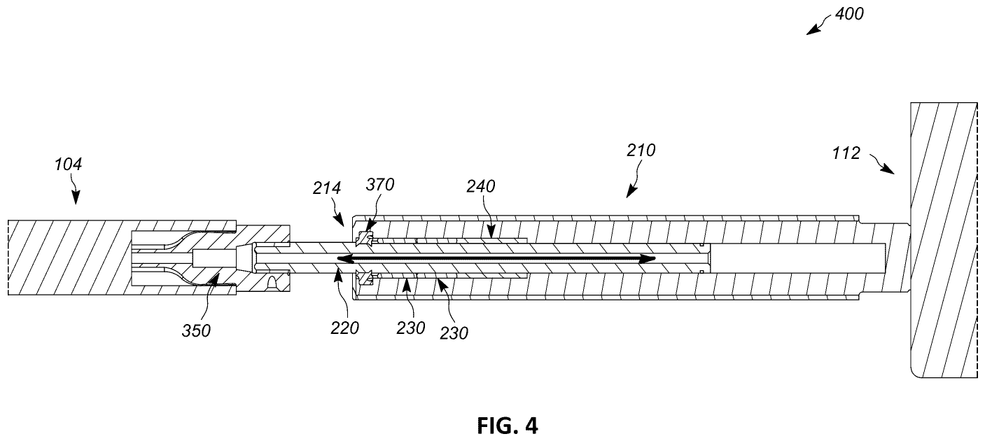

FIG. 4 illustrates a sectional view 400 of an example implementation of the dynamic connector 200 of FIG. 2. As the welding torch twists and turns (for example, as described in FIG. 1), the welding cable 104 is pushed, pulled, and twisted, causing the welding cable 124 to be pulled into and out of the stationary bore 214. The dynamic connector 200 provides additional rotation between the wire feeder 112 and the welding cable 104, thereby providing additional rotation and length to the welding cable 104. In some examples, the pin 220 slides toward and away from the wire feeder 112 and rotates along a longitudinal axis of the pin 220 as shown in FIG. 4. The length of the pin 220 is sufficiently long to avoid unintentional removal of the pin 220 within the expected movement envelope of the pin relative to the size of the bore 214. The pin 220 and welding cable 104 may be manufactured to preset lengths, and the conductive adapter 210 and bore may be manufactured to preset sizes based on different makes and models of robotic arms, welding torches, and wire feeders as described above with reference to FIG. 1, or based on welding-type applications or processes.

In some examples, the one or more electrical contact rings 230 maintain an electrical connection between the conductive adapter 210 and the pin 220, and the one or more bearings 240 support the pin 220. The welding cable 104 may be connected to the sliding pin at 350 via one or more fasteners, such as a threaded interface, locking screws, set screws, or a crimp connector as a list of non-limiting examples.

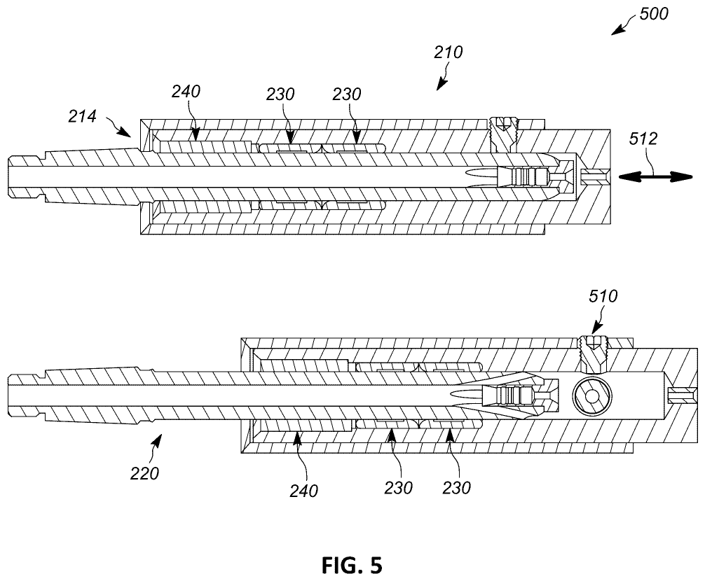

FIG. 5 is a sectional view of another example dynamic connector 500 that may be used to implement the dynamic connector 200 of FIG. 2. In some examples, the dynamic connector 200 may include a retaining fastener 510 such as a screw in order to lock the dynamic connector 200 in place. In some examples, engaging or locking the retaining fastener of the dynamic connector 200 limits travel of the pin 220 towards and away from the wire feeder. The retaining fastener 510 may completely lock the dynamic connector 500 while engaged, or may lock longitudinal movement of the pin 220 while engaged while allowing rotation of the pin 220. The retaining fastener may lock the pin 220 at a certain distance 512 from the wire feeder. The distance may be customized by an operator or based on a welding-type application or process.

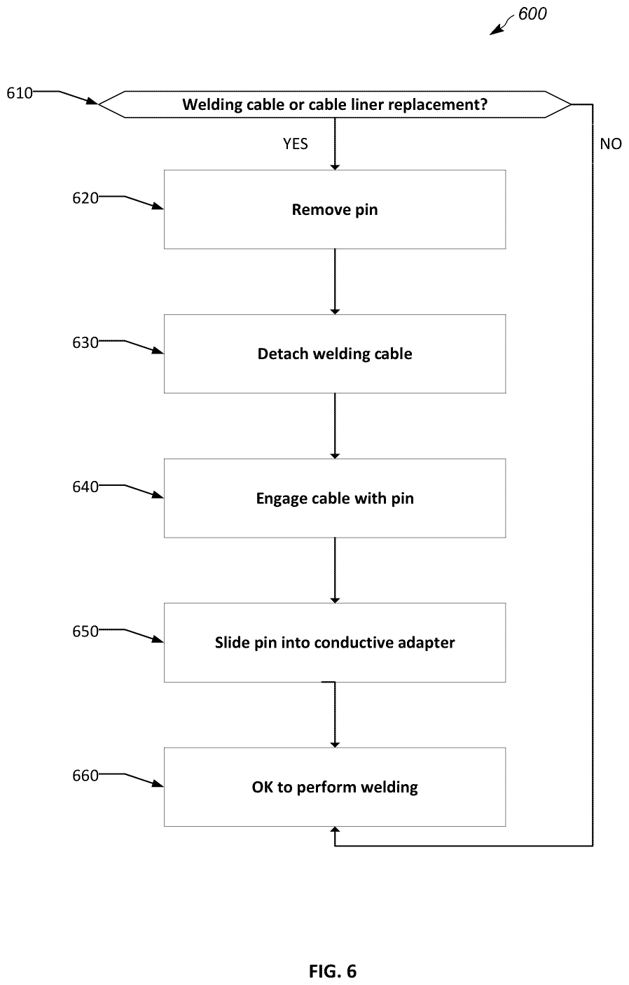

FIG. 6 is a flowchart 600 illustrating an example method of removing and replacing the welding cable 104 of FIG. 1. In some examples, when a welding cable or welding cable liner replacement is needed (block 610), the sliding pin may be removed from the dynamic connector by pulling the pin through the bore of the conductive adapter. If a retaining fastener (such as described in FIG. 5) is present and has been engaged, the retaining fastener is disengaged prior to removing the pin. The conductive adapter may remain in the wire feeder along with the cable liner retainer, and the pin is removed (block 620).

Once the pin is removed, the welding cable is detached from the pin (block 630). The replacement welding cable is attached to the pin (or a new replacement pin) (block 640), and the pin is inserted into the conductive adapter by sliding the pin into the conductive adapter (block 640). If the retaining fastener is being utilized, the retaining fastener is locked and welding may be performed (block 660).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A dynamic connector for a welding system comprising:
a conductive adapter configured to connect to a wire feeder on a first end and comprising a bore on a second end;
a pin positioned within the bore and configured to couple the conductive adapter to a welding cable, wherein the pin is configured to travel with respect to the bore in response to force on the welding cable;
one or more electrical contact rings configured to maintain an electrical connection between the conductive adapter and the pin while the pin is within the bore; and
one or more bearings configured to support the pin while the pin is within the bore.

2. The dynamic connector of claim 1, wherein the one or more electrical contact rings comprise a socket with spring-loaded contacts biased toward a longitudinal axis of the socket.

3. The dynamic connector of claim 2, wherein the pin is removable from the socket.

4. The dynamic connector of claim 1, wherein the dynamic connector is configured to rotate along an axis of the pin.

5. The dynamic connector of claim 1, further comprising a retention fastener is configured to limit travel of the pin.

6. The dynamic connector of claim 1, wherein the pin is configured to slide toward and away from the wire feeder.

7. The dynamic connector of claim 1, wherein the dynamic connector further comprises a spring configured to bias the welding cable away from the wire feeder.

8. The dynamic connector of claim 7, wherein the spring encircles a pair of telescoping tubes.

9. The dynamic connector of claim 1, further comprising a seal configured to reduce leakage of gas.

10. The dynamic connector of claim 1, further comprising a liner retainer configured to remain within the dynamic connector.

11. The dynamic connector of claim 1, further comprising a gas port configured to receive gas and provide the gas to the dynamic connector.

12. A robotic welding system comprising:
a robotic arm;
a welding cable;
a wire feeder;
a welding torch attached to the robotic arm; and
a dynamic connector, the dynamic connector comprising:
a conductive adapter configured to connect to the wire feeder on a first end and comprising a bore on a second end;
a pin positioned within the bore and configured to couple the conductive adapter to the welding cable, wherein the pin is configured to travel within the bore in response to force on the welding cable;
one or more electrical contact rings configured to maintain an electrical connection between the conductive adapter and the pin while the pin is within the bore; and
one or more bearings configured to support the pin while the pin is within the bore.
